(19) United States
(12) Patent Application Publication
(10) Pub. No.: US 2012/0150376 A1
(43) Pub. Date: Jun. 14, 2012

(54) INDEPENDENT CONTROL OF DRIVE AND NON-DRIVE WHEELS IN ELECTRIC VEHICLES

(75) Inventors: Raymond H. Ash, Cincinnati, OH (US); Donald L. Wires, Loveland, OH (US)

(73) Assignee: AMP ELECTRIC VEHICLES INC., Loveland, OH (US)

(21) Appl. No.: 13/323,898

(22) Filed: Dec. 13, 2011

Related U.S. Application Data
(60) Provisional application No. 61/422,696, filed on Dec. 14, 2010.

(51) Int. Cl. G05D 17/00

(52) U.S. Cl. 701/22

(57) ABSTRACT

In an electric vehicle including at least two drive wheels, an electric motor is operatively coupled to each drive wheel and a braking assembly is operatively coupled to each wheel. A controller is operatively coupled to each electric motor and each braking assembly for independently controlling the torque applied to each drive wheel and the braking pressure applied to each wheel. In a method of controlling an electric vehicle, a controller generates motor torque commands and sends them to each electric motor. The controller also generates brake pressure commands and sends them to each brake assembly associated with each wheel. In both the vehicle and the method, the controller may rely upon input received from sensors associated with the vehicle and may perform a control algorithm.

This application claims priority of U.S. Provisional Patent Application No. 61/422,696, filed Dec. 14, 2010, which is expressly incorporated herein by reference in its entirety.

### TECHNICAL FIELD

This invention relates to controlling the wheels of a vehicle, such as a car. More particularly, this invention relates to features for independently controlling the wheels of an electric vehicle so as to more precisely control stability, traction, differential speed and vehicle speed.

### BACKGROUND OF THE INVENTION

Electric four wheel vehicles (such as cars) commonly use one or more electric motors and some form of mechanical transmission or mechanical differential arrangement to deliver power from the electric motors to the drive wheels. Such arrangements are essentially conventional and may have efficiency losses attributable to the mechanical transmission and/or mechanical differential that drive the wheels. These losses may be compounded if an electric motor arrangement is also coupled to an internal combustion engine, such as in a hybrid configuration. Generally the losses in a hybrid configuration can be expected to be less than the total losses in an all internal combustion engine drive car with a conventional mechanical transmission and mechanical drive train.

Drive assemblies including one or more electric motors for delivering power to the drive wheels of an electric vehicle have been developed, with more lately-developed drive assemblies having done away with the conventional mechanical transmission or mechanical differential arrangement, or both, as shown in U.S. Patent Application Publication Nos. 2011/0114399; 2011/0115321; 2011/0115320 and International Publication No. WO 2011/060362, each of which is expressly incorporated in its entirety herein. In one example, a drive assembly includes two electric motors, with each electric motor driving a wheel. In particular, the output shaft of each motor is connected to a planetary gear assembly, which, in turn, is connected to a wheel through an axle and one or more continuous velocity joints. Such an arrangement eliminates the need for a conventional mechanical transmission because the electric motors may deliver appropriate levels of torque and speed for typical driving needs. And, because the output of the electric motors drives the wheels, a conventional mechanical differential is also unnecessary.

Because these lately-developed drive assemblies include a separate electric motor for each drive wheel, it is possible that at least each drive wheel may be independently controlled. Thus, a need exists in the art for improvements relating to controlling the wheels of an electric vehicle.

### SUMMARY OF THE INVENTION

Aspects of the present invention relate to controlling the wheels of a vehicle. In particular, the invention in one aspect relates to independently controlling at least two drive wheels of an electric vehicle, with an electric motor for providing torque to each drive wheel and a brake assembly for applying braking pressure to each drive wheel. The invention in another aspect also relates to independently controlling the brake assemblies for applying braking pressure to a vehicle's wheels, including the drive wheels and non-drive wheels.

According to one embodiment of the invention, an electric vehicle having a plurality of wheels includes at least two drive wheels, an electric motor operatively coupled to each drive wheel, a braking assembly operatively coupled to each wheel, and a controller operatively coupled to each electric motor and each braking assembly. The controller is for independently controlling the torque applied to each drive wheel and the braking pressure applied to each wheel.

According to another embodiment of the invention, a method of controlling an electric vehicle having a plurality of wheels, at least two drive wheels, an electric motor associated with each drive wheel, and a brake assembly associated with each wheel includes several steps. These steps may include: generating motor torque commands in a controller, sending the motor torque commands to each electric motor, generating brake pressure commands in the controller, and sending the brake pressure commands to each brake assembly.

According to another embodiment of the invention An electric vehicle having a plurality of wheels includes at least two drive wheels, at least one electric motor, each drive wheel operatively coupled to at least one electric motor, a braking assembly operatively coupled to each drive wheel, a plurality of sensors associated with the electric vehicle, and a controller operatively coupled to each electric motor and each braking assembly for independently controlling a torque applied to each drive wheel and a braking pressure applied to each drive wheel. The controller is configured to provide motor torque commands to each electric motor and brake pressure commands to each braking assembly. The controller is also operatively coupled to and receives inputs from the sensors, and the inputs include at least one of a steering wheel position, an accelerator pedal position, a brake pedal position, an operator gearshift lever position, a traction control status, a stability status switch, a cruise control status, a wheel status, a drive motor resolver status, a speedometer reading, a steering angle status, a brake pressure status, a wheel torque status, and a multi-axis acceleration status. The motor torque commands and the brake pressure commands are determined as part of a vehicle control algorithm that utilizes the inputs from the sensors, and the vehicle control algorithm includes at least one of a stability control algorithm, an anticipatory control algorithm, a traction control algorithm, a differential wheel speed algorithm, and a cruise control algorithm. The vehicle control algorithm provides an override motor torque command and a brake pressure command that override an operator's control.

### BRIEF DESCRIPTION OF THE DRAWINGS

The above-mentioned and other features and advantages of this invention, and the manner of attaining them, will become more apparent and the invention itself will be better understood by reference to the following description of embodiments of the invention taken in conjunction with the accompanying drawings, wherein:

FIG. 1A is a schematic representation of an electric vehicle having drive wheels, non-drive wheels, one or more electric motors associated with the drive wheels, braking assemblies associated with the drive wheels and non-drive wheels, and a controller;

FIG. 1B is a summary diagram that shows various inputs to and outputs from the controller used in association with the electric vehicle of FIG. 1A;

FIG. 2 shows a control sequence according to one embodiment of an integrated control algorithm used by the controller of FIG. 1B;

FIG. 3A shows details via a control flowchart of a stability control algorithm of the control sequence of FIG. 2;

FIG. 3B shows details via a control flowchart of an anticipatory control algorithm of the control sequence of FIG. 2;

FIG. 3C shows details via a control flowchart of a traction control algorithm of the control sequence of FIG. 2;

FIG. 4A shows details of a differential wheel speed control algorithm of the control sequence of FIG. 2; and

FIG. 4B shows details via a control flowchart of a cruise control algorithm of the control sequence of FIG. 2.

### DETAILED DESCRIPTION OF THE INVENTION

This invention relates to controlling the wheels of a vehicle. In particular, the invention relates to independently controlling the wheels of an electric vehicle. The vehicle may include at least two drive wheels, with an electric motor for providing torque to each drive wheel. The vehicle may also include brake assemblies for applying braking pressure to each wheel, including the drive wheels and non-drive wheels. While the following description is in the context of a vehicle with two drive wheels and two electric motors, it will be appreciated that the invention is equally applicable to a vehicle with other drive wheels and electric motor combinations.

Principally, a drive wheel may be controlled primarily by adjusting the amount of torque (rotational force) and braking pressure applied to it. A non-drive wheel may be controlled primarily by adjusting the amount of braking pressure applied to it. Changes in the torque applied to a drive wheel can adjust the rotational speed of the drive wheel, causing a vehicle to speed up or slow down. For example, increasing the amount of torque applied to a drive wheel will increase the rotational speed of the drive wheel, and decreasing the amount of torque will decrease the rotational speed. Changes in braking pressure applied to a wheel can also adjust the rotational speed of the wheel, with braking principally serving to slow a vehicle. For example, increasing the amount of brake pressure applied to a wheel tends to decrease the rotational speed of the wheel. According to this invention, the torque applied to each drive wheel and the braking pressure applied to each wheel may be independently controlled, thereby providing improved stability, traction, differential speed and vehicle speed control.

To implement independent control of a vehicle's wheels, a controller is provided that receives inputs from various sensors associated with the vehicle and sends output instructions relating to the torque and braking pressure to be applied to each wheel. In particular, the output instructions may take into consideration the various inputs.

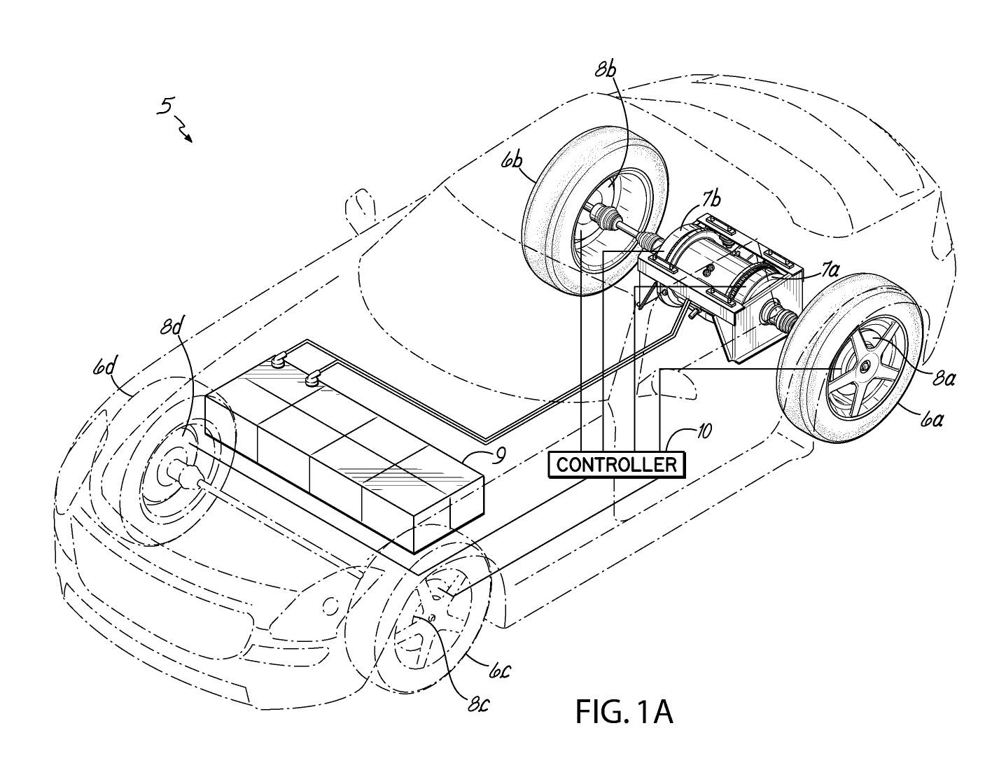

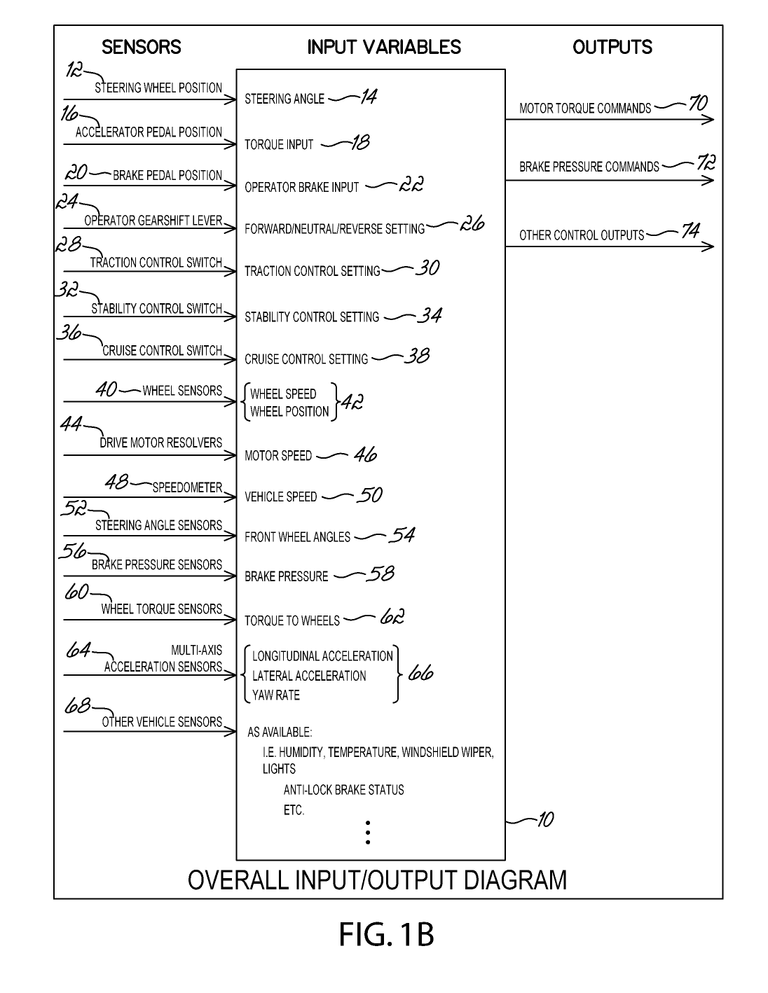

Referring first to FIG. 1A, an electric vehicle 5 is shown, which has four wheels, including drive wheels 6a and 6b, non-drive wheels 6c and 6d, electric motors 7a and 7b associated with the drive wheels 6a, 6a, respectively, braking assemblies 8a, 8b, 8c, and 8d associated with the wheels 6a, 6b, 6c, and 6d, and a power source 9 for providing electric power to various features of the vehicle 5 according to one embodiment of this invention. A controller 10 is provided in one aspect for controlling the vehicle's wheels, and is operatively coupled to the electric motors 7a, 7b, and the braking assemblies 8a, 8b, 8c, and 8d. The controller 10 is also operatively coupled with various sensors (not shown) associated with features of the vehicle 5.

Referring to FIG. 1B, selected input and output instructions relating to the controller 10 are shown. The controller 10 is configured to receive various inputs from sensors associated with the vehicle 5. Exemplary inputs are shown in FIG. 1B. These inputs may be associated with operator-controlled features, such as brake pedal position, as well as features that may be only indirectly associated with the operator's control, such as wheel speed. The controller 10 is further configured to use the information from the inputs to determine conditions of the vehicle 5, as will be described.

For example, and as shown in FIG. 1B, the controller 10 may receive input from a sensor for detecting the steering wheel position, such as at 12. It will be appreciated that a steering wheel is generally used by an operator to control the direction of movement of a vehicle, such as vehicle 5, by changing the steering angle of a pair of the vehicle's wheels (typically, the front wheels 6c, 6d). The input 12 may be used by the controller 10 to determine a steering angle, such as at 14.

The controller 10 may also receive input from a sensor for detecting an accelerator pedal position, such as at 16. An accelerator pedal is generally used by an operator to control the speed of a vehicle by depressing the accelerator pedal to increase the vehicle's speed. The position of an accelerator pedal may indicate the relative desired amount of torque (more or less torque) an operator wishes to apply to the drive wheels 6a, 6b. Thus, the input 16 may be used by the controller 10 to determine a desired torque input from the user, such as at 18.

The controller 10 may also receive input from a sensor for detecting a brake pedal position, such as at 20. A brake pedal is generally used by an operator to control the braking, or slowing, of a vehicle by brake assemblies that slow the rotation of wheels 6a, 6b, 6c, 6d. The position of a brake pedal may indicate the desired amount of brake pressure an operator wishes to apply to the wheels. Thus, the input 20 may be used by the controller 10 to determine a desired brake input from the user, such as at 22.

The controller 10 may also receive input from a sensor for detecting an operator gearshift lever position, or selection, such as at 24. A gearshift lever, or other similar feature, is generally used by an operator to choose the direction of driven movement of a vehicle, such as forward, neutral (no driven movement), and reverse. The position or selection of a gearshift lever may indicate the direction an operator wishes the vehicle to move, such as when an operator wishes to move the vehicle forward, the gearshift lever is placed in the forward position. Thus, the input 24 may be used by the controller 10 to determine a desired direction setting, such as forward, neutral, or reverse, as at 26.

The controller 10 may also receive input from a sensor for detecting a traction control switch position, or selection, such as at 28. A traction control switch, or other similar feature, is generally used by an operator to control the activation and deactivation of a traction control system in the vehicle. A traction control system is generally understood as including features for preventing or remediating the loss of traction between the drive wheels 6a, 6b and the road. The position or selection of a traction control switch may indicate whether an operator wishes for a traction control system to be activated or not. Thus, the input 28 may be used by the controller 10 to determine a desired traction control setting, such as at 30.

The controller 10 may also receive input from a sensor for detecting a stability control switch position, or selection, such as at 32. A stability control switch, or other similar feature, is generally used by an operator to control the activation and deactivation of a stability control system in the vehicle. A stability control system is generally understood as including features for preventing or remediating the loss of steering control. The position or selection of a stability control switch may indicate whether an operator wishes for a stability control system to be activated or not. Thus, the input 32 may be used by the controller 10 to determine a desired stability control setting, such as at 34.

In some instances, the activation and deactivation features of a traction control system and a stability control system may be combined so that an operator can adjust a single control switch to activate or deactivate both at the same time. Also in some instances, either or both of a traction control system and a stability control system may not be included in a vehicle.

The controller 10 may also receive input from a sensor for detecting a cruise control switch position, or selection, such as at 36. A cruise control switch, or other similar feature, is generally used by an operator to set or control a desired constant speed for the vehicle, such as may be used on highways where a constant speed may be maintained for relatively long periods of time. A cruise control system is generally understood as including features for maintaining a vehicle at a chosen speed. The position or selection of a cruise control switch may indicate whether an operator wishes for a cruise control system to be activated or not, as well as for setting and adjusting a desired speed. Thus, the input 36 may be used by the controller 10 to determine a desired cruise control setting, such as at 38. In some instances, a cruise control system may not be included in a vehicle.

Thus, various inputs 12 (steering wheel position), 16 (accelerator pedal position), 20 (brake pedal position), 24 (operator gearshift lever), 28 (traction control switch), 32 (stability control switch), and 36 (cruise control switch) generally relate to features that may be controlled, essentially directly, by an operator or driver. In addition to these operator-controlled features, the controller 10 is configured to receive inputs from sensors relating to features that are only minimally operator-controlled, if at all.

For example, and with continued reference to FIG. 1B, the controller 10 may receive input from one or more sensors for monitoring the vehicle's wheels, including the drive wheels 6a, 6b and the non-drive wheels 6c, 6d, such as at 40. The input 40 may be used by the controller 10 to determine information about the wheels, including wheel speed and wheel position, such as at 42. The information 42 may be determined for each wheel individually, including drive wheels and non-drive wheels.

The controller 10 may also receive input from one or more sensors, such as resolvers, for monitoring the vehicle's electric motors, such as at 44. The input 44 may be used by the controller 10 to determine the motor speed for each electric motor, such as at 46. In one embodiment, the vehicle 5 and associated motor(s) may be as shown in U.S. patent application Ser. No. 13/283,663, filed Oct. 28, 2011 and hereby incorporated entirely by reference.

The controller 10 may also receive input from one or more sensors, such as speedometers, for monitoring the vehicle's speed, as at 48. The input 48 may be used by the controller 10 to determine the vehicle's speed, as at 50.

The controller 10 may also receive input from one or more steering angle sensors for monitoring the angle of the vehicle's wheels used for steering (typically the front wheels 6c, 6d) with respect to a forward-direction axis, such as at 52. The input 52 may be used by the controller 10 to determine the front wheel angles, such as at 54.

The controller 10 may also receive input from one or more brake pressure sensors for monitoring the braking pressure being applied by braking assemblies 8a, 8b, 8c, 8d to the vehicle's wheels 6a, 6b, 6c, 6d, such as at 56. The input 56 may be used by the controller 10 to determine brake pressure values, such as at 58.

The controller 10 may also receive input from one or more wheel torque sensors for monitoring the torque being applied to the vehicle's drive wheels, such as at 60. The input 60 may be used by the controller 10 to determine the torque being applied to the drive wheels, such as at 62.

The controller 10 may also receive input from one or more acceleration sensors, such as multi-axis acceleration sensors, monitoring the acceleration of the vehicle in several directions, as at 64. The input 64 may be used by the controller 10 to determine the vehicle's acceleration, which may be determined on a directional basis, including the vehicle's longitudinal acceleration, lateral acceleration, and yaw rate, as at 66.

In addition, the controller 10 may receive input from one or more other vehicle sensors as well, such as 68. These inputs may be used by the controller 10 to determine information about the vehicle, such as temperature, windshield wiper status, light status, humidity, anti-lock brake status, and/or other aspects of the vehicle.

The controller 10 is configured to receive the various inputs discussed above, to determine information based on those inputs, and to generate output instructions. Particularly, the controller 10 generates motor torque commands, as at 70, and brake pressure commands, as at 72. The motor torque commands 70 may relate to and may be generated for each electric motor 7a and/or 7b. Similarly, the brake pressure commands 72 may relate to and may be generated for the braking assembly associated with each wheel, including the drive wheels and non-drive wheels. Additional output instructions may also be generated by the controller 10, such as other control outputs at 74. The controller 10 may include any general purpose processor and software capable of performing the functions described herein.

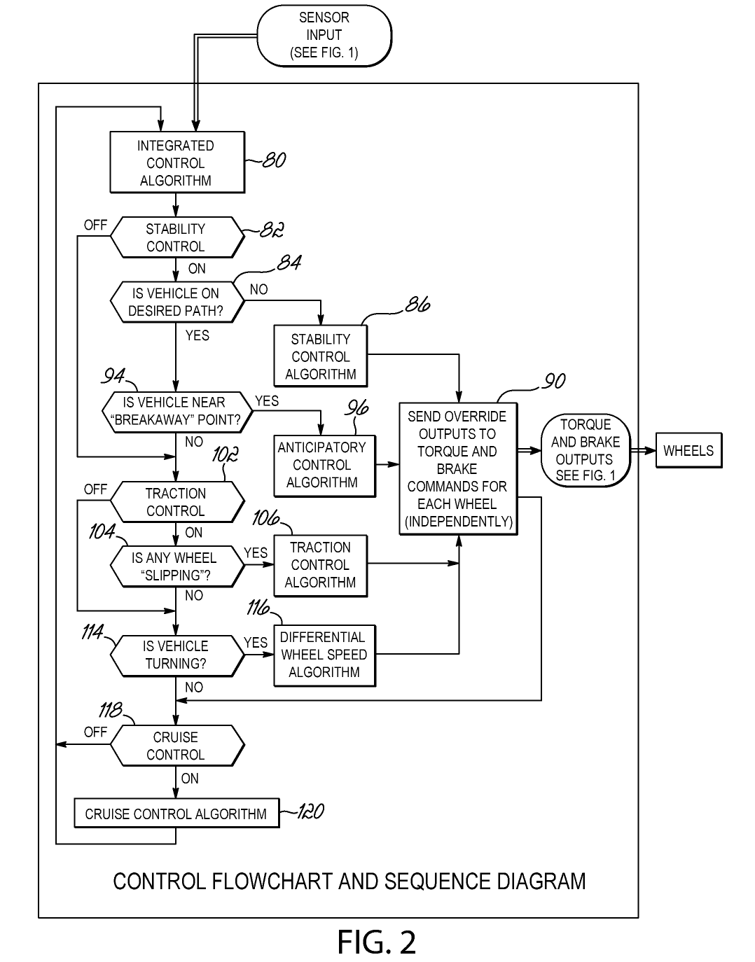

Turning next to FIG. 2, the controller 10 may use a control sequence provided by an integrated control algorithm 80 as part of generating the motor torque commands 70 and the brake pressure commands 72. The integrated control algorithm 80 may use the inputs and the determined information discussed above with respect to FIG. 1B.

As part of the control sequence of the integrated control algorithm 80, the controller 10 may query whether the vehicle's stability control system is on or off, such as at 82. The controller 10 may refer to the stability control setting 34 to answer this query. If the stability control system is off (or if a stability control system is not included in the vehicle), the integrated control algorithm 80 proceeds to another step in its control sequence. If the stability control system is on, the controller 10 queries whether the vehicle is travelling along a desired path, such as at 84.

As part of the consideration of whether the vehicle is travelling along a desired path, the controller 10 may use any number of the available inputs or determined information, such as, for example, the lateral acceleration and yaw rate information determined at 66. Lateral acceleration or yaw rate values falling outside reasonably anticipated values may indicate that the vehicle is sliding or spinning, and therefore no longer travelling along a desired path. If the vehicle is not on a desired path, a stability control algorithm is activated, such as at 86. If the vehicle is on a desired path, the integrated control algorithm 8o proceeds to another step in its control sequence.

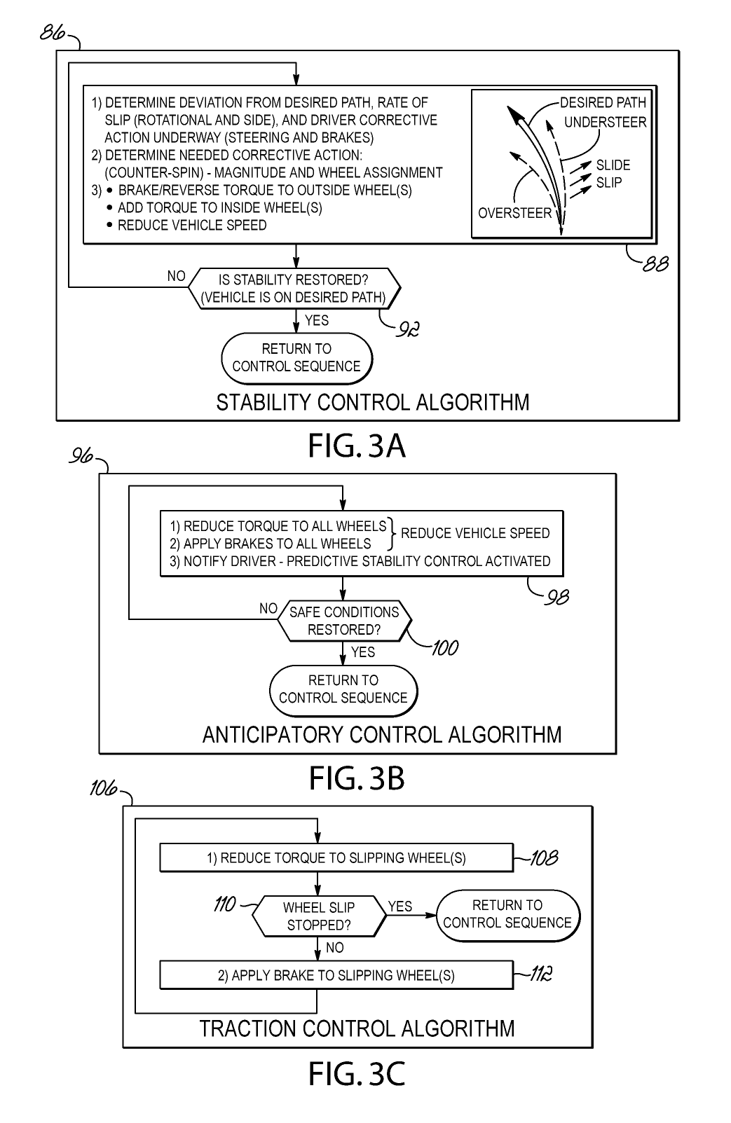

Referring to FIG. 3A, selected features of the stability control algorithm 86 are shown. At 88, the controller 10 may determine the deviation from a desired path, the rate of slip of one or more wheels (rotational and side-to-side slipping), and whether the operator is taking corrective action, such as steering or braking in a way that may indicate corrective action. The controller 10 may also determine a corrective action, which may relate to adjusting the wheel torque applied to one or more drive wheels to counter the spin in the one or more slipping drive wheels. Optional corrective actions may also include applying braking pressure or modifying the torque (such as reversing or reducing the torque) to the wheels on the side of the vehicle in the direction of the slip (outside wheels), increasing the torque applied to the drive wheel on the side of the vehicle away from the direction of the slip (inside wheels), and reducing the vehicle's speed. The determination of the corrective actions may be made for each wheel individually. The corrective actions may then be sent by the controller 10 as motor torque commands 70 and/or brake pressure commands 72, which may be override outputs that override the operator's control and which may be applied to each wheel independently, such as at 90 (FIG. 2).

The stability control algorithm 86 may also query whether stability is restored to the vehicle, as at 92. If not, the stability control algorithm 86 returns to 88. If stability is restored, the stability control algorithm 86 returns to the control sequence of the integrated control algorithm 80.

The control sequence of the integrated control algorithm 86 may also query whether the vehicle is near a breakaway point, as at 94. A breakaway point is generally understood as a state when the vehicle may be in unsafe conditions and the risk of diminished operator control is increased. If the vehicle is near a breakaway point, an anticipatory correction algorithm is activated, as at 96.

Referring to FIG. 3B, selected features of the anticipatory correction algorithm 96 are shown. At 98, the controller 10 may adjust, such as by reducing, the torque applied to each drive wheel by sending appropriate motor torque commands 70. The controller 10 may also adjust, such as by increasing, the braking pressure applied to the wheels by sending appropriate brake pressure commands 72. The controller 10 may also cause an indication to be provided so as to notify the operator that predictive stability control has been activated. The motor torque commands 70 and brake pressure commands 72 sent as part of the stability control algorithm 86 may be override outputs 90 that override the operator's control, as discussed above.

The anticipatory control algorithm 96 also may query whether safe conditions have been restored, as at 100. If not, the anticipatory control algorithm 96 returns to 98. If safe conditions have been restored, the anticipatory control algorithm 96 returns to the control sequence of the integrated control algorithm 80.

The control sequence of the integrated control algorithm 80 may also query whether the traction control system is on or off, as at 102. The controller 10 may refer to the traction control setting 30 to answer this query. If the traction control system is off (or if a traction control system is not included in the vehicle), the integrated control algorithm 80 proceeds to another step in its control sequence. If the traction control system is on, the controller 10 queries whether any wheel is slipping, such as at 104. The controller may refer to any of the inputs or determined information to answer this query, including for example, the wheel speed at 42, the motor speed at 46, and the vehicle speed at 50. Generally, when a drive wheel is slipping, the wheel speed will be out of relationship with the vehicle speed. If no wheel is slipping, the integrated control algorithm 80 proceeds to another step in its control sequence. If any wheel is slipping, a traction control algorithm is activated, as at 106.

Referring to FIG. 3C, selected features of the traction control algorithm 106 are shown. At 108, the controller 10 may reduce the torque applied to each slipping wheel by sending appropriate motor torque commands 70. The traction control algorithm may query whether wheel slip has stopped, as at 110. If wheel slip has stopped, the traction control algorithm 106 returns to the control sequence of the integrated control algorithm 80. If wheel slip has not stopped, the controller 10 may apply increased braking pressure to each slipping wheel, as at 112. This may be accomplished by controller 10 sending appropriate brake pressure commands 72. The motor torque commands 70 and brake pressure commands 72 sent as part of the traction control algorithm 106 may be override outputs 90 that override the operator's control, as discussed above.

The control sequence of the integrated control algorithm 86 may also query whether the vehicle is turning, as at 114. If the vehicle is not turning, the integrated control algorithm 80 proceeds to another step in its control sequence. If the vehicle is turning, a differential wheel speed algorithm is activated, as at 116.

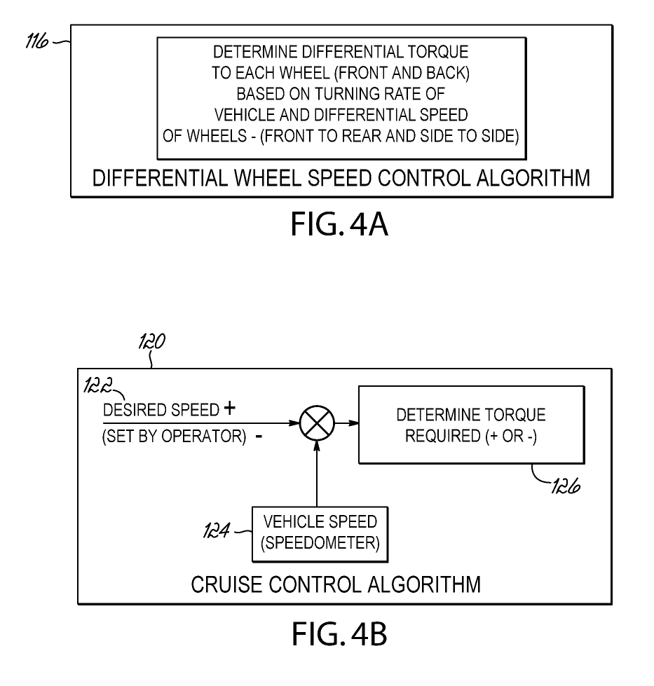

Referring to FIG. 4A, selected features of the differential wheel speed algorithm 116 are shown. The differential torque to each wheel may be determined, such as based on the turning rate of the vehicle and the differential speed of the wheels (front to rear and side to side). If desired, motor torque commands 70 or brake pressure commands 72 may be generated as part of the differential wheel speed control algorithm 116, and may be override outputs 90 that override the operator's control, as discussed above.

The control sequence of the integrated control algorithm 80 may also query whether the cruise control system is on or off, as at 118. The controller 10 may refer to the cruise control setting 38 to answer this query. If the cruise control system is off, the integrated control algorithm 80 proceeds to another step in its control sequence. If the cruise control system is on, a cruise control algorithm is activated, as at 120.

Referring to FIG. 4B, selected features of the cruise control algorithm 120 are shown. At 122, a desired speed is determined, which may be set by an operator. At 124, the vehicle speed is determined. The controller 10 may refer to the vehicle speed 50 for this information. The controller 10 may then determine the torque required to change the vehicle's speed to the desired speed, as at 126. The controller 10 may adjust, such as by increasing or decreasing, the torque applied to each drive wheel by sending appropriate motor torque commands 70. The motor torque commands 70 sent as part of the cruise control algorithm 120 may be override outputs 90 that override the operator's control, as discussed above.

Thus, the present invention in one aspect provides for the independent control of the wheels in an electric vehicle. In particular, independent control may be exercised over the drive wheels and independent braking control is exercised over all wheels, including drive wheels and non-drive wheels. By independently controlling the wheels, improved stability, traction, differential speed and vehicle speed may be achieved.

From the above disclosure of the general principles of the present invention and the preceding detailed description of at least one embodiment, those skilled in the art will readily comprehend the various modifications to which this invention is susceptible. Therefore, we desire to be limited only by the scope of the following claims and equivalents thereof.

We claim:

1. An electric vehicle having a plurality of wheels, comprising:
at least two drive wheels;
at least one electric motor, each drive wheel operatively coupled to at least one electric motor;
a braking assembly operatively coupled to each drive wheel; and
a controller operatively coupled to each electric motor and each braking assembly for independently controlling a torque applied to each drive wheel and a braking pressure applied to each drive wheel.

2. The electric vehicle of claim 1, further comprising:
a plurality of sensors associated with the electric vehicle;
wherein the controller is operatively coupled to and receives inputs from the sensors.

3. The electric vehicle of claim 1, wherein the inputs include at least one of a steering wheel position, an accelerator pedal position, a brake pedal position, an operator gearshift lever position, a traction control status, a stability status switch, a cruise control status, a wheel status, a drive motor resolver status, a speedometer reading, a steering angle status, a brake pressure status, a wheel torque status, and a multi-axis acceleration status.

4. The electric vehicle of claim 2, wherein the controller is configured to provide motor torque commands to each electric motor and brake pressure commands to each braking assembly.

5. The electric vehicle of claim 4, wherein the motor torque commands and the brake pressure commands are determined as part of a vehicle control algorithm.

6. The electric vehicle of claim 5, wherein the vehicle control algorithm utilizes the inputs from the sensors.

7. The electric vehicle of claim 5, wherein the vehicle control algorithm includes a stability control algorithm.

8. The electric vehicle of claim 5, wherein the vehicle control algorithm includes an anticipatory control algorithm.

9. The electric vehicle of claim 5, wherein the vehicle control algorithm includes a traction control algorithm.

10. The electric vehicle of claim 5, wherein the vehicle control algorithm includes a differential wheel speed algorithm.

11. The electric vehicle of claim 5, wherein the vehicle control algorithm includes a cruise control algorithm.

12. The electric vehicle of claim 5, wherein the vehicle control algorithm provides an override motor torque command and a brake pressure command that override an operator's control.

13. A method of controlling an electric vehicle having a plurality of wheels, at least two drive wheels, at least two electric motors, each associated with one of the drive wheels, and at least two brake assemblies, each associated with one of the wheels, the method comprising:
generating motor torque commands in a controller;
sending the motor torque commands to each electric motor;
generating brake pressure commands in the controller; and
sending the brake pressure commands to each brake assembly.

14. The method of claim 13, further comprising:
receiving inputs in the controller from sensors associated with the electric vehicle.

15. The method of claim 14, further comprising:
performing a control algorithm in the controller for generating the motor torque commands and the brake pressure commands.

16. The method of claim 15, wherein the control algorithm includes at least one of a stability control algorithm, an anticipatory control algorithm, a traction control algorithm, a differential wheel speed algorithm, and a cruise control algorithm.

17. The method of claim 15, wherein at least one of the motor torque commands and the brake pressure commands are override commands that override an operator's control of the electric motors and the brake assemblies.

18. An electric vehicle having a plurality of wheels, comprising:
at least two drive wheels;
at least one electric motor, each drive wheel operatively coupled to at least one electric motor;
a braking assembly operatively coupled to each drive wheel;
a plurality of sensors associated with the electric vehicle;
a controller operatively coupled to each electric motor and each braking assembly for independently controlling a torque applied to each drive wheel and a braking pressure applied to each drive wheel, the controller being configured to provide motor torque commands to each electric motor and brake pressure commands to each braking assembly;
wherein the controller is operatively coupled to and receives inputs from the sensors, the inputs including at least one of a steering wheel position, an accelerator pedal position, a brake pedal position, an operator gearshift lever position, a traction control status, a stability status switch, a cruise control status, a wheel status, a drive motor resolver status, a speedometer reading, a steering angle status, a brake pressure status, a wheel torque status, and a multi-axis acceleration status;
wherein the motor torque commands and the brake pressure commands are determined as part of a vehicle control algorithm that utilizes the inputs from the sensors, the vehicle control algorithm including at least one of a stability control algorithm, an anticipatory control algorithm, a traction control algorithm, a differential wheel speed algorithm, and a cruise control algorithm; and
wherein the vehicle control algorithm provides an override motor torque command and a brake pressure command that override an operator's control.
